(19) United States
(12) Patent Application Publication
(10) Pub. No.: US 2022/0381055 A1
(43) Pub. Date: Dec. 1, 2022

(54) ASSISTIVE DEVICE FOR DOORS

(71) Applicant: Jay Q Innovations Inc., Richmond (CA)

(72) Inventors: John Hamilton, Richmond (CA); Alexander Knoll, Surrey (CA)

(73) Assignee: Jay Q Innovations Inc., Richmond (CA)

(21) Appl. No.: 17/336,161

(22) Filed: Jun. 1, 2021

(51) Int. Cl. E05B 1/00

(52) U.S. Cl. CPC E05B 1/0053

(57) ABSTRACT

An assistive device for a door having a door lock mounted adjacent to a doorknob. The door lock is rotationally actuatable via a thumb lever. The assistive device comprises a handle adapted to mount on to the thumb lever without obstructing the doorknob and a mounting slot formed between opposed ends of the handle for forming a frictional fit between the handle and the thumb lever. The handle includes an elongated end configured to provide leverage for rotation of the thumb lever using the handle, and an arcuate end for grasping. The mounting slot at least partially surrounds the thumb lever in a plane of rotation thereof.

### TECHNICAL FIELD

The disclosure relates generally to devices for making interaction with doors easier for individuals with disabilities, arthritis or other debilitating conditions.

### BACKGROUND

Infirm individuals require assistance in living day-to-day life. Routine tasks may become exceedingly difficult. Such difficulties may be specific to a person's condition and the nature of the task to be carried out.

U.S. Pat. No. 7,975,352 B2 to Landin discloses a device which provides a way to open a door with a traditional rounded doorknob. The device includes finger-like extensions that snap in place to grip the doorknob. The device provides an extension that functions as a lever on the doorknob.

U.S. Pat. No. 6,669,241 B1 to Kelley discloses a door latch opening system, including an engaging member and a receiver member. The receiver member is disposed behind and covered by the engaging member and is used to couple with an elongated and planar door latch handle. The engaging member may be square, oval, or rectangular and is used to interact with the door latch handle via the receiver member.

U.S. Pat. No. 9,982,461 B1 to Kilbourne discloses a lock adapter assembly which includes a battery-powered motor assembly to provide a rotational force to actuate a deadbolt lock actuator.

### SUMMARY

Identifying obstacles faced by infirm individuals is important for developing assistive devices. Such individuals may have difficulty in not only actuating doorknobs but may also face difficulty in unlocking door locks which are rotationally actuatable, e.g. deadbolt locks actuated by thumb-levers.

Door locks are often disposed adjacent to the door locks and may be difficult to open due to not only required leverage (or torque) but also hand dexterity. For example, relatively fine manipulation by fingers may be needed to actuate thumb levers on door locks. Assistive devices placed on doorknobs may obstruct assistive devices on door locks. Installing assistive devices on door locks may be difficult for infirm individuals if they require excessive force or relatively complex placement of the assistive device.

In some aspects, there are disclosed assistive devices for door locks which frictionally engage with thumb levers on door locks via mounting slots. The mounting slots may keep the thumb lever exposed for ease of placement and may be configured to frictionally engage as much as necessary to avoid use of excessive force, while maintaining sufficient engagement to prevent inadvertent dislodgement of the assistive device from the door lock.

In one aspect, the disclosure describes an assistive device for a door lock mounted adjacent to a doorknob on a door, the door lock being rotationally actuatable via a thumb lever, the assistive device comprising: a handle adapted to mount on to the thumb lever without obstructing the doorknob, the handle including an arcuate end, and an elongated end opposed the arcuate end configured to provide leverage for rotation of the thumb lever using the handle; and a mounting slot formed in the handle between the arcuate end and the elongated end, the mounting slot configured to form a friction fit between the handle and the thumb lever by at least partially surrounding the thumb lever in a plane of rotation of the thumb lever.

The arcuate end may be a semi-circular end with a radius less than a distance between the doorknob and the thumb lever. The arcuate end may be a semi-circular end with a radius of at least 1 inch (25.4 mm). The arcuate end may be a semi-circular end with a radius between 0.75 and 1.25 inches (19 and 32 mm). The elongated end may be a V-shaped end converging away from the arcuate end. The mounting slot may be open normal to the plane of rotation. The friction fit may inhibit relative motion between the handle and the thumb lever. The assistive device may be of unitary construction. The mounting slot may frictionally engage with two opposed surfaces of the thumb lever at least partially lateral to a direction of elongation of the thumb lever. The arcuate end may be configured to at least partially surround an axis of rotation of the thumb lever. The handle may comprise a plurality of recesses therein.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a door lock mounted adjacent to a doorknob on a door;

FIG. 2A is a front perspective view of an exemplary assistive device for a door lock of a door;

FIG. 2B is a rear perspective view of the assistive device of FIG. 2A;

FIG. 3 is a front elevation view of an exemplary assistive device installed on a door lock on a door;

FIG. 4A is a front perspective view of an assistive device for a door lock of a door, in accordance with another embodiment; and

FIG. 4B is a rear perspective view of the assistive device of FIG. 4A.

### DETAILED DESCRIPTION

The following disclosure relates to assistive devices for doors. In some embodiments, the devices disclosed herein can facilitate engagement of infirm individuals with door locks having thumb levers requiring dexterity and leverage to actuate.

Aspects of various embodiments are described in relation to the figures.

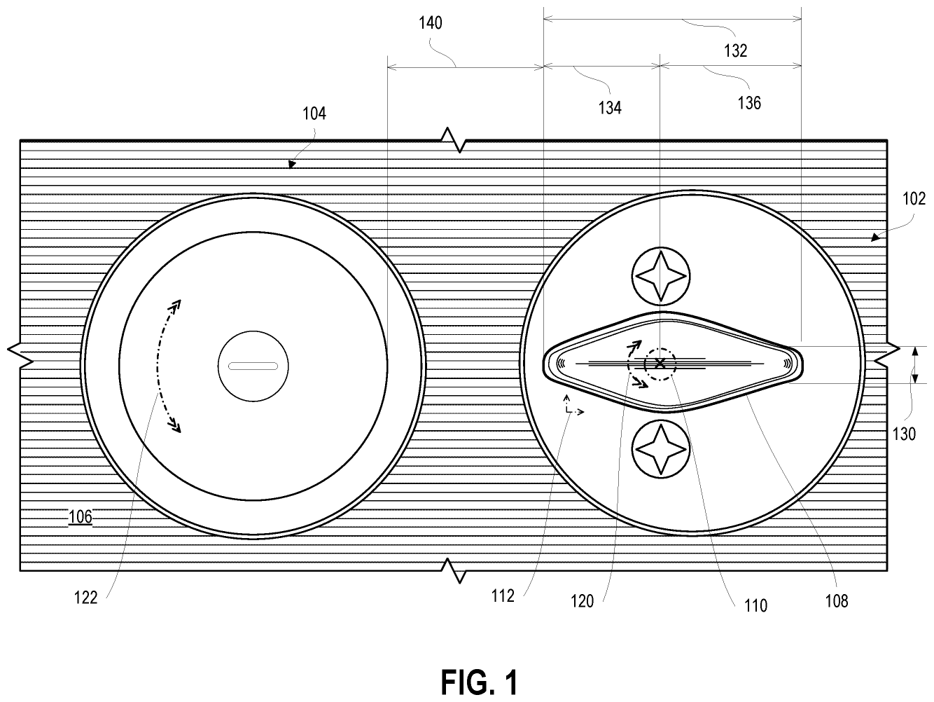

FIG. 1 is a door lock 102 mounted adjacent to a doorknob 104 on a door 106.

Such door locks may be commonly found on exterior doors on homes and commercial buildings. The door locks are paired with the doorknobs. Whereas the doorknobs are generally used for opening and closing doors by engaging/disengaging door latches from latch receptacles in door-frames, door locks are used to prevent unauthorized entry or provide an additional level of security to prevent such entry. In some cases, the doorknob 104 also has a built-in lock to prevent rotation of the doorknob 104.

The doorknob 104 may be resiliently rotatably to disengage, and also possibly engage, with a door latch (see rotational direction 122). For disengagement, the doorknob 104 may operate under continuously applied torque, e.g. the doorknob 104 may be rotationally spring-loaded. The continuous torque may be difficult to apply for infirm individuals and thus devices may be installed on the doorknob 104 to provide leverage. Such devices generally do not interfere with the door locks, as door locks are significantly smaller than doorknobs.

In general, doorknobs may be dimensioned sufficiently large to achieve required torques for actuation and to facilitate grasping by human hands. As such the doorknob 104 may be relatively large in comparison to the door lock 102 and set apart from the door 106, such that any devices installed thereon may remain spaced apart from the door lock 102 as well.

The door lock 102 may be a deadbolt lock. The door lock 102 may include a thumb lever 108. The thumb lever 108 may be rotatable about an axis of rotation 110 defining a plane of rotation 112. The door lock 102 may be rotationally actuatable (see rotation direction 120) via the thumb lever 108 to adopt one of two conditions, locked or unlocked. In some embodiments, a continuous torque may not be required to keep the door lock 102 in a desired condition (locked or unlocked).

Thumb levers may be adapted for actuation via fingers and may be significantly smaller than the adjacent doorknob 104. Like doorknobs, thumb levers may be rotatably actuatable by applying a sufficient amount of torque. Thumb levers may require hand dexterity for grasping and maintaining frictional contact therewith while applying torque, e.g. unlike (certain) doorknobs. Thumb levers may require finger manipulation due to their relatively small size. Finger manipulation may be especially challenging for individuals with joint pain, e.g. those suffering with arthritis.

In various embodiments, the thumb lever 108 may have a width 130 of 0.626 inches (16 mm) or between 0.4 and 0.8 inches (10 and 20 mm). In some cases, actuating the thumb lever 108 may require hand dexterity sufficient to bring fingers together between 0.4 to 0.8 inches (10 to 20 mm) apart from each other, or less.

In various embodiments, the thumb lever 108 may have a length 132 of 1.375 inches (35 mm), or between 1-1.5 inches (25.4-38 mm) in length. In some embodiments, the thumb lever 108 may be pivoted in-between its two ends, e.g. a moment arm 134 of length between 0.3-0.5 inches (7.6-12.7 mm) and a moment arm 136 of length between 0.6-1.0 inches (15.2-25.4 mm) may result.

Assistive devices installed on the door lock 102 may be adapted to avoid obstructing the adjacent doorknob 104. For example an assistive device may be dimensioned so that a width thereof is less than a distance 140 between the doorknob and door lock.

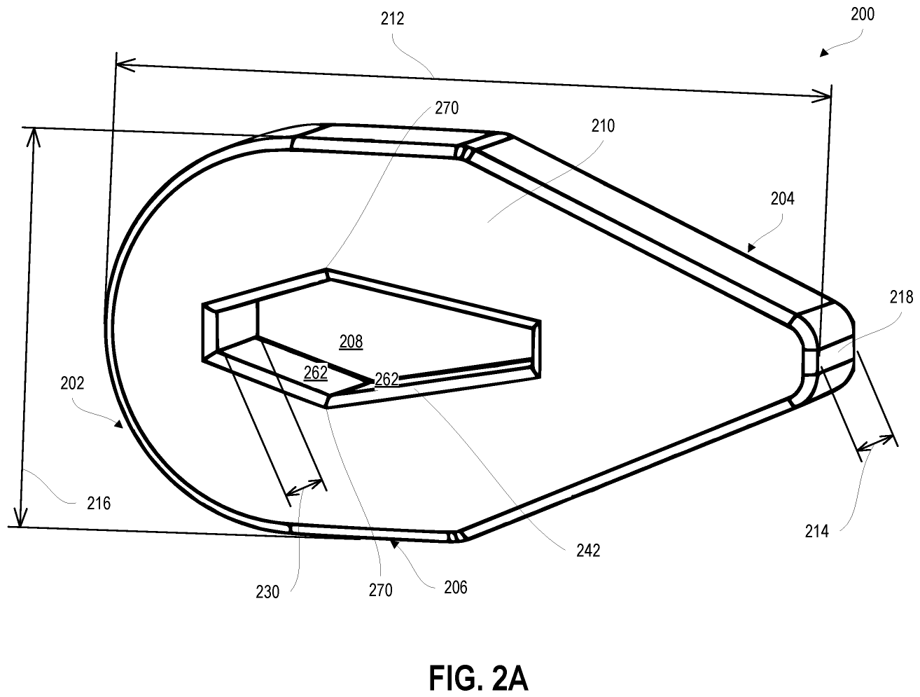

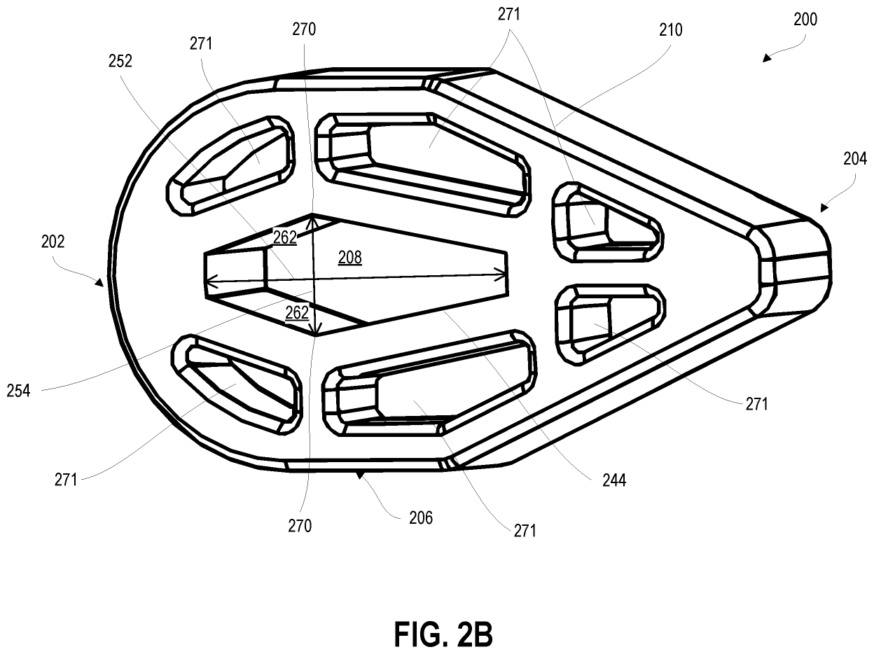

FIG. 2A is a front perspective view of an exemplary assistive device 200 for the door lock 102 of the door 106.

FIG. 2B is a rear perspective view of the assistive device 200 of FIG. 2A.

The assistive device 200 may comprise a handle 210 including an arcuate end 202, and an elongated end 204 opposed the arcuate end 202. In some embodiments, the arcuate end 202 and the elongated end 204 define an extension 212 of the handle 210 of about 4 inches (100 mm). A rectangular portion 206 may be disposed between the arcuate end 202 and elongated end 204. A depth 214 of the handle 210 may be less than 1 inch (25.4 mm), or about 0.75 inches (19 mm). In some embodiments, the depth may be adapted to the dimensions of the thumb lever 108.

The arcuate end 202 may be a semi-circular end with radius less than a distance between the doorknob 104 and the thumb lever 108. In some embodiments, the semi-circular end has a radius (half of a diameter 216) of at least about 1 inch (or 1.0625 inch) (25.4, or 27 mm); or between 0.75 and 1.25 inches (19 and 31.75 mm) and may be adapted to grasping by hand.

The elongated end 204 may be a V-shaped end converging away from the arcuate end 202. The apex 218 of the V-shape end may rounded and disposed at an extreme end of the assistive device 200. The converging shape may allow a user to grasp the handle 210 at a position that provides the appropriate leverage and sufficient size to allow grasping with relatively less dexterity. The converging shape ensures the doorknob is not obstructed when the handle is rotated (to actuate the thumb lever 108).

A mounting slot 208 may be formed in the handle 210 between the arcuate end 202 and the elongated end 204. The mounting slot 208 may be non-circular and comprise frictional surfaces 262 adapted to (e.g. deformably) adhere to the surface of the thumb lever 108. For example, in some embodiments, the mounting slot 208 may be substantially diamond-shaped, or diamond-shaped with blunted longitudinal ends. In various embodiments, the waist of the diamond-shape may be adapted to an outer shape of the thumb lever 108.

The mounting slot 208 may include a front (or outer) end 242 (FIG. 2A) and a rear (or inner) end 244 (FIG. 2B). The front end 242 may be configured to at least partially expose the rear opening (or rear end 244) of the slot. The rear end 244 may be configured to grasp on the thumb lever 208.

An inner (or rear) length 252 of the mounting slot 208 may be between 1.5-2 inches (38-50.8 mm). In some embodiments, the inner length 252 may be about 1.75 inches (44.5 mm). An inner width 254 of the mounting slot 208 may be between 0.5-1.0 inches (12.7-25.4 mm). In some embodiments, the inner width 254 may be 0.625 inches (15.9 mm). An inner depth 230 of the mounting slot 208 may be between 0.5-1.0 inches (12.7-25.4 mm). In some embodiments, the inner depth 230 may be 0.75 inches (19 mm).

In the embodiment shown in FIG. 2B, the handle 210 includes a plurality of recesses 271. In general, any number of recesses 271 may be employed. The use of a recess 271 advantageously reduces material costs in manufacturing the handle 210. Depending on the material(s) selected for the handle 210 and the number and dimensions of the recesses 271, one or more recesses 271 in various embodiments provide resilience of feel for the user when gripping the handle 210, especially when gripping at the sides of the handle 210, provide deformability of the mounting slot 208, or provide both resilience of feel and mounting slot 208 deformability.

The assistive device 200 may be of unitary construction. In some embodiments, the handle 210 may be injection moulded using rubber, plastic (hardened) or cast using metal. The slot-in-handle configuration may be amenable to unitary construction and may reduce cost and improve reliability. Hardened plastics and metals may be employed to reduce flexure during operation and effort required for engagement.

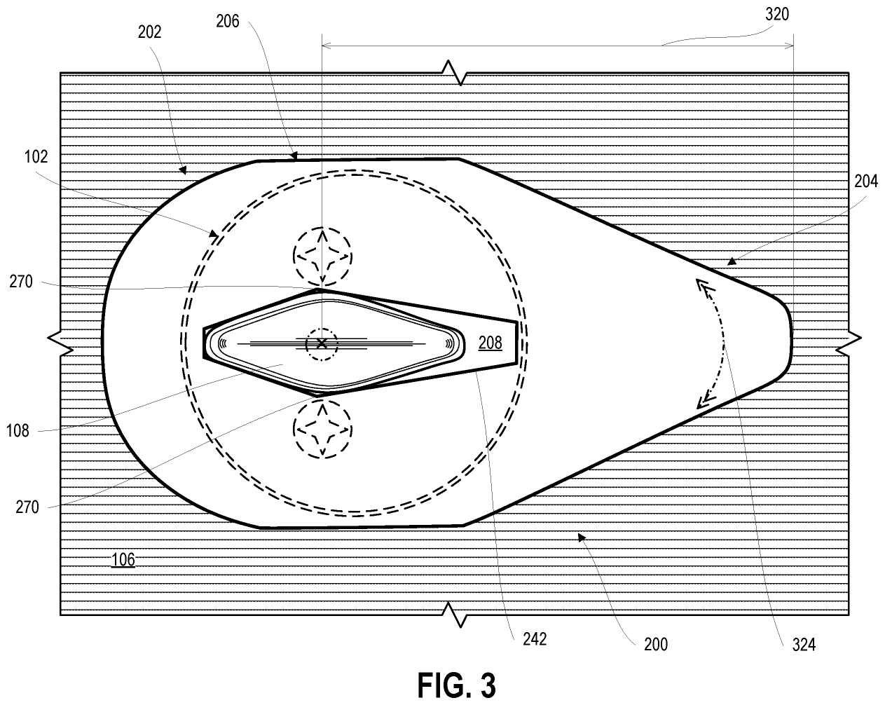

FIG. 3 is a front elevation view of an exemplary assistive device 200 installed on the door lock 102 on the door 106. The door lock 102 is adjacent to the doorknob 104 (see FIG. 1).

The handle 210 may be adapted to mount on to the thumb lever 108 without obstructing the doorknob 104.

The arcuate end 202 may be configured to at least partially surround and may extend circumferentially around the axis of rotation 110 (FIG. 1) of the thumb lever 108. The arcuate end 202 and/or the rectangular portion 206 may be configured to provide a larger surface for a user to rotate the thumb lever 108, e.g. to reduce a required level of dexterity for manipulating the thumb lever 108. The thumb lever 108 may be effectively enlarged by the handle 210.

The elongated end 204 may be configured to provide leverage for rotation of the thumb lever 108 using the handle 210. The elongated end 204 may provide a relatively larger moment arm for manipulating the thumb lever 108.

The mounting slot 208 may be configured to form a friction fit between the handle 210 and the thumb lever 108 by at least partially surrounding the thumb lever 108 in the plane of rotation 112 of the thumb lever 108. The mounting slot 208 may deformably engage with the thumb lever 108. The thumb lever 108 may be at least partially surrounded circumferentially thereabout.

The mounting slot 208 may frictionally engage with two opposed surfaces of the thumb lever 108 at least partially lateral to a direction of elongation of the thumb lever 108. In some embodiments, the two opposed surfaces may be opposed longitudinal (in the elongated direction) surfaces of a diamond-shaped slot.

The thumb lever 108 may be only partially in frictional contact with the mounting slot 208. The mounting slot 208 (or an inner surface, such as frictional surface 262, thereof) may only be partially in frictional contact with the mounting slot 208. Frictional contact may only be at a waist or other narrowed portion of a diamond-shaped slot. In various embodiments, frictional contact may be reduced to facilitate ease of installation but may be sufficient to prevent dislodgement of the assistive device 200.

The friction fit may inhibit or completely stop relative motion between the handle 210 and the thumb lever 108, e.g. there may be substantially little to no wiggle room, which may facilitate ease of engagement of the thumb lever 108.

The mounting slot 208 may be open normal to the plane of rotation 112. For example, the thumb lever 108 may be exposed through the mounting slot 208 after the assistive device 200 is mounted thereon. Keeping the thumb lever 108 exposed may facilitate locating the assistive device 200 relative to the thumb lever 108 to allow ease of installation, which may otherwise be difficult for certain populations of users.

A moment arm 320 may provide leverage to make rotatably actuating the thumb lever 108 easier along the rotational direction 324.

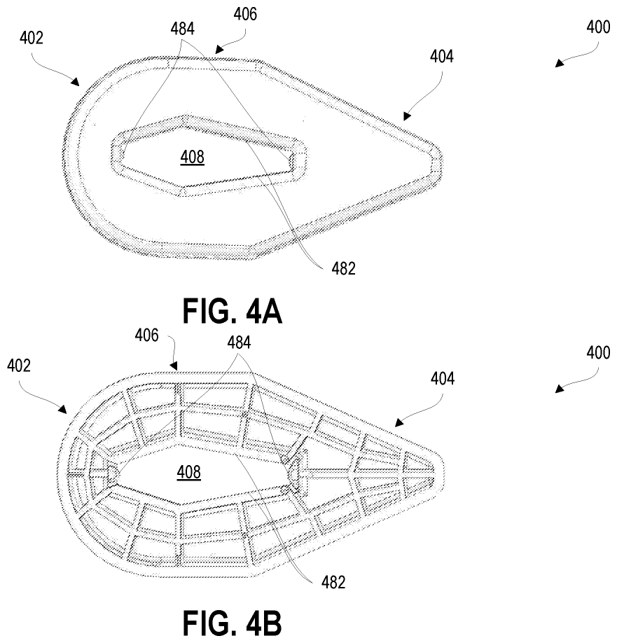

FIG. 4A is a front perspective view of an assistive device 400 for a door lock 102 of the door 106, in accordance with another embodiment.

FIG. 4B is a rear perspective view of the assistive device 400 of FIG. 4A.

The assistive device 400 has an arcuate end 402, an elongated end 404 with a rectangular portion 406 therebetween, and a mounting slot 408.

The mounting slot 408 may be formed may comprise two non-contiguous opposed surfaces 482. Protrusions 484 may be provided between the two opposed surfaces 482. Such a configured may facilitate forming a friction fit with the thumb lever 108. Gaps or spaces may be formed between the opposed surfaces 482 (and the protrusions 484) to make deformation of the mounting slot 408 easier, which may ease installation of the assistive device 400.

As can be understood, the examples described above and illustrated are intended to be exemplary only.
The embodiments described in this document provide non-limiting examples of possible implementations of the present technology. Upon review of the present disclosure, a person of ordinary skill in the art will recognize that changes may be made to the embodiments described herein without departing from the scope of the present technology. For example, materials other than rubber, plastic or metal may be used, slots may be adapted to varying door lock configurations, and thumb levers may include small rotatably actuatable components that are not necessarily diamond-shaped. Yet further modifications could be implemented by a person of ordinary skill in the art in view of the present disclosure, which modifications would be within the scope of the present technology.

What is claimed is:

1. An assistive device for a door lock mounted adjacent to a doorknob on a door, the door lock being rotationally actuatable via a thumb lever, the assistive device comprising:
(a) a handle adapted to mount on to the thumb lever without obstructing the doorknob, the handle including:
(i) an arcuate end, and
(ii) an elongated end opposed the arcuate end configured to provide leverage for rotation of the thumb lever using the handle; and
(b) a mounting slot formed in the handle between the arcuate end and the elongated end, the mounting slot configured to form a friction fit between the handle and the thumb lever by at least partially surrounding the thumb lever in a plane of rotation of the thumb lever.

2. The assistive device of claim 1, wherein the arcuate end is a semi-circular end with a radius less than a distance between the doorknob and the thumb lever.

3. The assistive device of claim 1, wherein the arcuate end is a semi-circular end with a radius of at least 1 inch (25.4 mm).

4. The assistive device of claim 1, wherein the arcuate end is a semi-circular end with a radius between 0.75 inches (19 mm) and 1.25 inches (32 mm).

5. The assistive device of claim 1, wherein the elongated end is a V-shaped end converging away from the arcuate end.

6. The assistive device of claim 1, wherein the mounting slot is open normal to the plane of rotation.

7. The assistive device of claim 1, wherein the friction fit inhibits relative motion between the handle and the thumb lever.

8. The assistive device of claim 1, wherein the assistive device is of unitary construction.

9. The assistive device of claim 1, wherein the mounting slot frictionally engages with two opposed surfaces of the thumb lever at least partially lateral to a direction of elongation of the thumb lever.

10. The assistive device of claim 1, wherein the arcuate end is configured to at least partially surround an axis of rotation of the thumb lever.

11. The assistive device of claim 1, wherein the handle comprises a plurality of recesses therein.

12. The assistive device of claim 2, wherein the elongated end is a V-shaped end converging away from the arcuate end.

13. The assistive device of claim 12, wherein the mounting slot is open normal to the plane of rotation.

14. The assistive device of claim 13, wherein the friction fit inhibits relative motion between the handle and the thumb lever.

15. The assistive device of claim 14, wherein the assistive device is of unitary construction.

16. The assistive device of claim 15, wherein the mounting slot frictionally engages with two opposed surfaces of the thumb lever at least partially lateral to a direction of elongation of the thumb lever.

17. The assistive device of claim 16, wherein the arcuate end is configured to at least partially surround an axis of rotation of the thumb lever.

18. The assistive device of claim 17, wherein the handle comprises a plurality of recesses therein.

19. The assistive device of claim 18, wherein the radius is at least 1 inch (25.4 mm).

20. The assistive device of claim 18, wherein the radius is between 0.75 inches (19 mm) and 1.25 inches (32 mm).
